(19) United States
(12) Patent Application Publication
(10) Pub. No.: US 2017/0133832 A1
(43) Pub. Date: May 11, 2017

(54) Electrical Cable Splice and Method For Connecting Power Cables

(71) Applicant: Tyco Electronics Raychem GmbH, Ottobrunn (DE)

(72) Inventors: Denny Hellige, Neubiberg (DE); Thomas Rohde, Bad Aibling (DE); Ladislaus Kehl, Unterhaching (DE)

(73) Assignee: Tyco Electronics Raychem GmbH, Ottobrunn (DE)

(21) Appl. No.: 15/413,542

(22) Filed: Jan. 24, 2017

Related U.S. Application Data
(63) Continuation of application No. PCT/EP2014/066059, filed on Jul. 25, 2014.

(51) Int. Cl. H02G 15/18; H02G 1/14; H01R 4/72

(52) U.S. Cl. CPC H02G 15/1806; H01R 4/726; H02G 1/14

(57) ABSTRACT

An electrical cable splice is disclosed. The electrical cable splice comprises a dimensionally recoverable sleeve covering a connection region of a plurality of joined together conductive cores. The dimensionally recoverable sleeve mechanically and electrically connects the conductive cores to each other.

### CROSS-REFERENCE TO RELATED APPLICATION

This application is a continuation of PCT International Application No. PCT/EP2014/066059, filed on Jul. 25, 2014.

### FIELD OF THE INVENTION

The present invention relates to an electrical cable splice for electrically connecting at least two power cables and to a corresponding method for electrically connecting at least two power cables.

### BACKGROUND

Many applications require an electrically conductive connection between two or more power cables. It is well known in the art to connect respective wires of the cables to be joined by soldering, welding, crimping, or by means of a mechanical joint involving a crimp, a ring, a nut, and a bolt. When reconnecting power cables in an emergency situation, however, these known connection techniques are too complicated and expensive.

### SUMMARY

An object of the invention, among others, is to provide a simple and cost-effective electrical cable splice for electrically connecting power cables safely and with sufficient mechanical stability. The disclosed electrical cable splice comprises a dimensionally recoverable sleeve covering a connection region of a plurality of joined together conductive cores. The dimensionally recoverable sleeve mechanically and electrically connects the conductive cores to each other.

### BRIEF DESCRIPTION OF THE DRAWINGS

The invention will now be described by way of example with reference to the accompanying figures, of which:

FIG. 1 is a sectional view of an electrical cable splice according to the invention;

FIG. 2 is top view of parts of the electrical cable splice of FIG. 1;

FIG. 3 shows a first step for assembling the electrical cable splice of FIG. 1;

FIG. 4 shows a second step for assembling the electrical cable splice of FIG. 1;

FIG. 5 is a sectional view of FIG. 4;

FIG. 6 shows a next step for assembling the electrical cable splice of FIG. 1;

FIG. 7 is a sectional view of FIG. 6;

FIG. 8 shows a final step for assembling the electrical cable splice of FIG. 1; and

FIG. 9 is a sectional view of the electrical cable splice of FIG. 1 in a final mounted state.

### DETAILED DESCRIPTION OF THE EMBODIMENT(S)

The invention is explained in greater detail below with reference to embodiments of an electrical cable splice. This invention may, however, be embodied in many different forms and should not be construed as limited to the embodiments set forth herein; rather, these embodiments are provided so that this disclosure will be thorough and complete and still fully convey the scope of the invention to those skilled in the art.

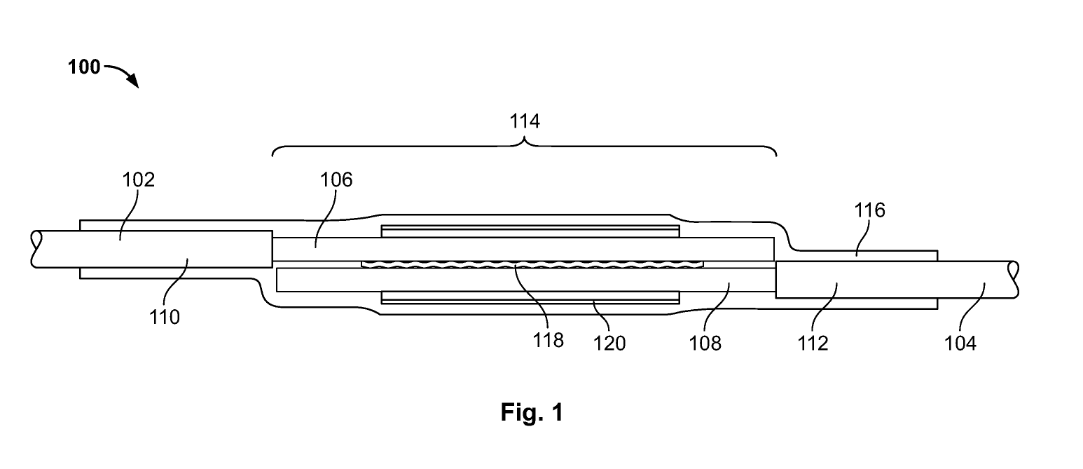

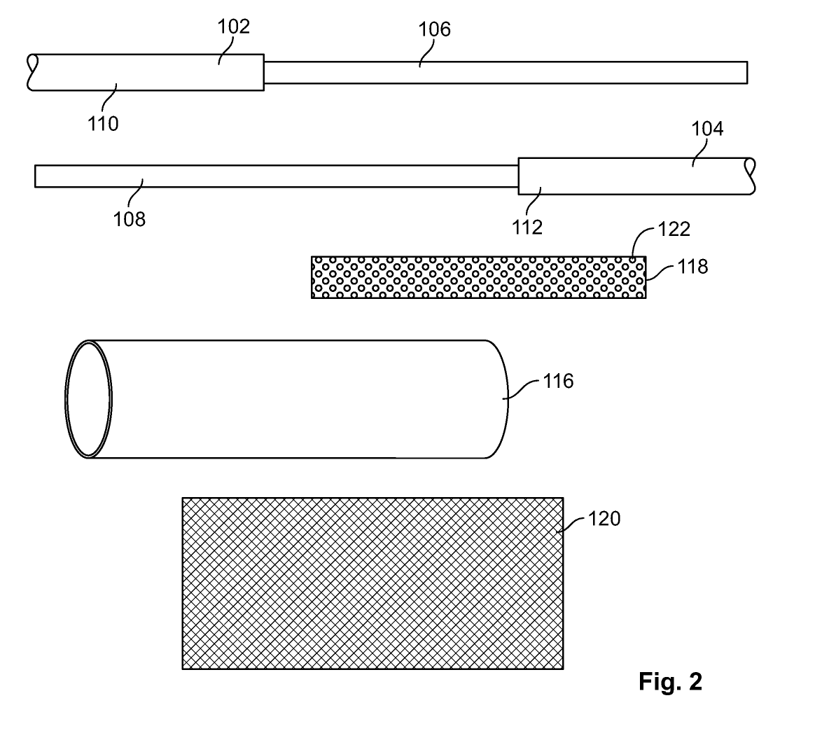

An electrical cable splice 100 according to the invention is shown generally in FIG. 1. Two power cables 102, 104 are connected to each other by the cable splice 100. Each of the power cables 102, 104 has an electrically conductive core 106, 108 and an insulating layer 110, 112 covering the respective electrically conductive cores 106, 108. For establishing the electric connection, the cores 106, 108 have to be exposed by stripping the insulating layer 110, 112 in a connection region 114. The parts comprising the cable splice 100 are shown separately in FIG. 2 in a pre-assembled state.

The two cable cores 106, 108 are put into contact with each other by overlying them with a predefined length of overlap equal to the length of the connection region 114 in FIG. 1. The two electrically conductive cores 106, 108 can directly be connected to each other a dimensionally recoverable sleeve 116 which covers the joined power cable cores 106, 108 at least in their region of overlap.

The dimensionally recoverable sleeve 116 may be formed from a heat shrink material. For such a heat shrink material a plastic material can be used which is semicrystalline and cross-linkable. In a final mounted state, shown in FIG. 1, the dimensionally recoverable sleeve 116 has a wall thickness of about 4 mm. As would be understood by one with ordinary skill in the art, other suitable thicknesses may be used. Alternatively, a cold shrink material could be used for the dimensionally recoverable sleeve 116.

An extraction force of 2.5 kN required for interrupting an electrical connection between the cables 102, 104 can be achieved with the electrical cable splice 100 of FIG. 1. In order to achieve a sufficiently high degree of contact pressure between the conductive cores 106, 108, a thermal expansion coefficient of a material of the dimensionally recoverable sleeve 116 should be sufficiently high for the maximum application temperature and above. In embodiments of the invention, the dimensionally recoverable sleeve 116 has a thermal expansion coefficient of more than 300 μm/m.K and may be in a range between 400 and 600 μm/m.K.

In order to achieve a sufficiently high tensile strength in combination with the thermal expansion rate, in embodiments of the invention, the Young's modulus of the dimensionally recoverable sleeve 116 is at least 600 N/mm², and may be in the range between 900 and 1100 N/mm².

Usual temperatures occurring during the operation of common power cables are around 70° C. Hence, a rated maximum application temperature to avoid melting should be above 90° C., such as between 110 and 120° C.

An exemplary suitable material for the dimensionally recoverable sleeve 116 is high-density polyethylene (HDPE). HDPE has a temperature stability that is as high as 130° C. This material also shows a thermochromatic behavior in that it is translucent above a critical temperature and is milky white below this temperature. Thus, during the operation, an overheating of the cable splice 100 through the contact can easily be detected by using the sleeve 116 as a temperature indicator. Other materials can be used for the dimensionally receoverabl sleeve 116 if the application temperature that is required is lower. For instance, for a maximum temperature of 60° C., low-density polyethylene (LDPE), polyoxymethelene (POM) or polyamide 12 (PA 12) are suitable materials. Other materials may also be used when the cross sections of the wires are smaller.

Prior to assembly, the dimensionally recoverable sleeve 116 as a heat shrink material is in an expanded state as shown in FIG. 2. If the dimensionally recoverable sleeve 116 is a cold shrink material, the sleeve 116 would be stored in an expanded state supported for instance by a removable spiral, as is well known in the art.

The cable splice 100, as shown in FIG. 1, may further comprise a contact 118 disposed between the two electrically conductive cores 106, 108 in at least a part of the connection region 114. The contact 118, as shown in FIG. 2, is formed by a flat metal sheet having punched-through holes 122 forming stamped protrusions which provide sharp edges, creating a roughened surface on two opposing sides of the contact 118. The protrusions puncture the outer surface of the cores 106, 108 for contacting both contact planes of the respective power cables 102, 104. The contact 118 may be a stamped copper beryllium sheet. The contact 118 enhances the electrical connection between the cables 102, 104 and increases the frictional and thereby required extraction forces of the cable splice 100.

An electrically conductive flexible sheath 120, as shown in FIG. 1, is disposed between the two cores 106, 108 and within the sleeve 116. The sheath 120 may be a woven or braided metal mesh, for instance fabricated from copper. The flexible sheath 120, in the embodiment shown in FIG. 2, is formed by an essentially rectangular piece of copper mesh, which is wrapped around the cores 106, 108. The sheath 120 may alternatively be tube-shaped. The sheath 120 further optimizes the mechanical and electrical performance of the cable splice 100.

Other multilayer structures, for instance a double layer structure as disclosed in European patent EP 1 702 391 B1 can be used for holding together the power cables 102, 104 within the splice 100.

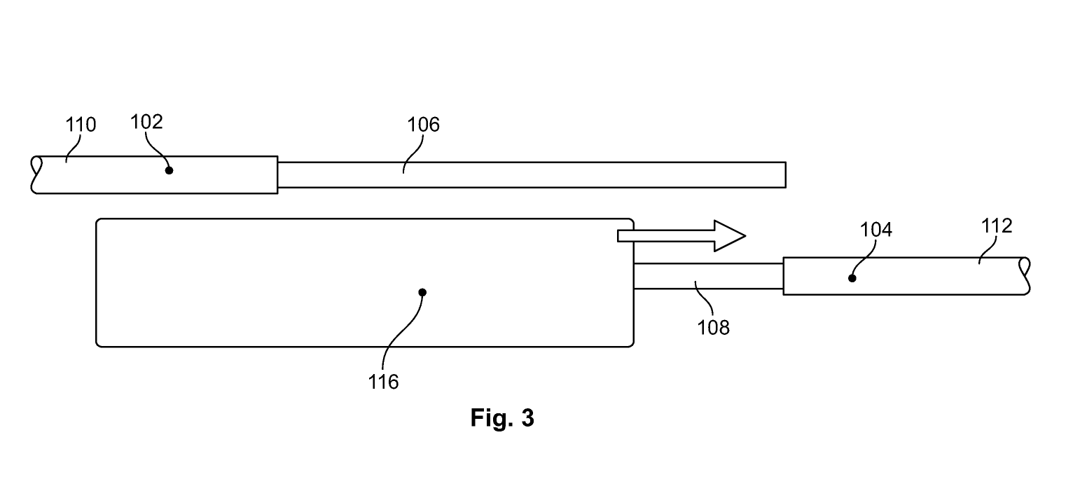

The individual steps for forming the cable splice 100 will now be described with reference to FIGS. 3-9.

As shown in FIG. 3, after having stripped bare the ends of the cores 106, 108 of two or more power cables 102, 104, the assembly method starts with positioning the dimensionally recoverable sleeve 116 over one of the power cables 102, 104 to be connected.

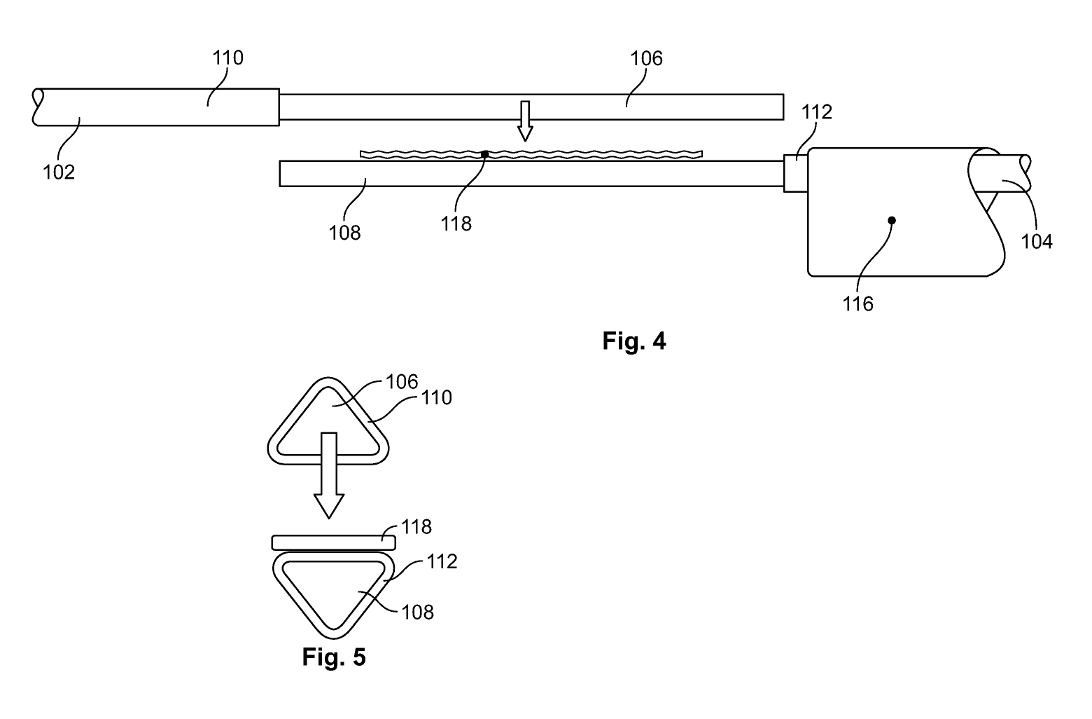

In a next step shown in FIGS. 4 and 5, the contact 118 is positioned on one of the cores 106, 108 and the other core 106, 108 is moved to abut the contact 118 and the one of the cores 106, 108. As shown in the embodiment of FIG. 5, the cross section of the wires forming the cores 106, 108 is triangular and has a flattened area for establishing contact, however, any other suitable cross-sectional form is of course also compatible with the principles of the present invention. Circular or sectional forms may also be connected with each other by the cable splice 100.

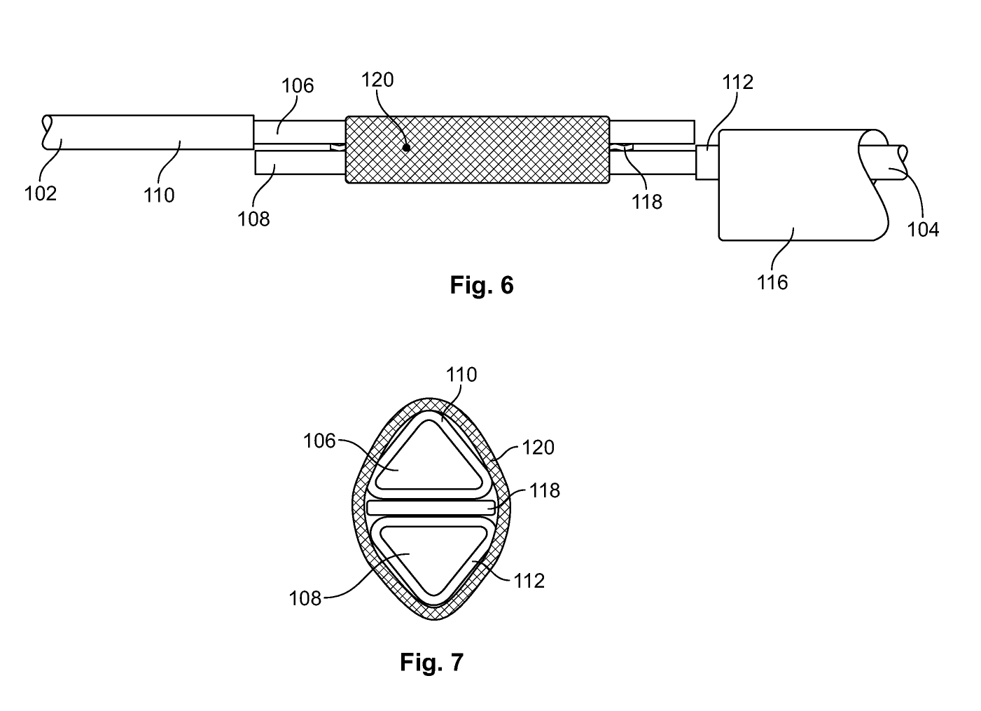

Subsequently, as shown in FIGS. 6 and 7, the electrically conductive flexible sheath 120 is wrapped once or twice around the cores 106, 108 and the contact element 118.

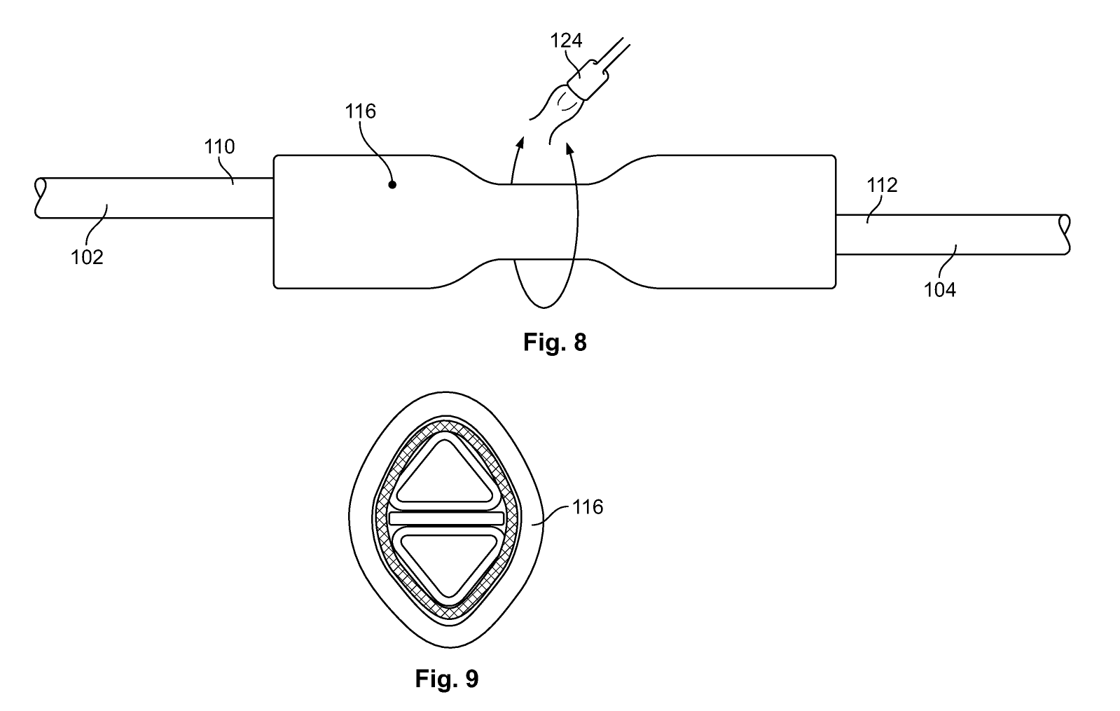

The final step is shown in FIGS. 8 and 9. The dimensionally recoverable sleeve 116 is shrunk by a heat source 124 and thereby electrically and mechanically fixes the contact 118 between the two cores 106, 108. As described above, instead of the heat source 124, also the removal of a supporting structure can lead to the sleeve 116 recovering its initial shape. The sleeve 116 is long enough to securely contact the insulating layers 110, 112 of the first and second power cables 102, 104. In a peripheral area an additional clamping piece encompassing the dimensionally recovered sleeve 116 can be provided for further improving the mechanical stability.

Advantageously, the electrical cable splice 100 according to the present invention is simple to install and inexpensive to keep on hand. Furthermore, no special tools are required for the assembly and a wide range of cable diameters and cross-sectional forms can be connected to one another by the splice 100. Thus, in emergency situations, a fast and reliable reconnection of broken power cables can be achieved.

What is claimed is:

1. An electrical cable splice, comprising:
a dimensionally recoverable sleeve covering a connection region of a plurality of joined together conductive cores, the dimensionally recoverable sleeve mechanically and electrically connecting the conductive cores to each other.

2. The electrical cable splice of claim 1, wherein each of the conductive cores is an exposed portion of a power cable.

3. The electrical cable splice of claim 1, wherein the conductive cores have a predetermined length of overlap in the connection region.

4. The electrical cable splice of claim 1, wherein the dimensionally recoverable sleeve is a heat shrink material or a cold shrink material.

5. The electrical cable splice of claim 1, further comprising a contact disposed between the conductive cores in the connection region.

6. The electrical cable splice of claim 5, wherein the contact is a flat, electrically conductive sheet having a roughened surface on each of two opposite sides of the contact.

7. The electrical cable splice of claim 1, further comprising an electrically conductive flexible sheath disposed between the dimensionally recoverable sleeve and the conductive cores in the connection region.

8. The electrical cable splice of claim 7, wherein the flexible sheath is a woven or braided metal.

9. The electrical cable splice of claim 1, wherein at least one of the conductive cores has a cross section with a flattened area.

10. The electrical cable splice of claim 1, wherein the dimensionally recoverable sleeve has a thermal expansion coefficient greater than 300 μm/m.K.

11. The electrical cable splice of claim 10, wherein the thermal expansion coefficient is between 400 and 600 μm/m.K.

12. The electrical cable splice of claim 1, wherein the dimensionally recoverable sleeve has a Young's modulus greater than 600 N/mm².

13. The electrical cable splice of claim 12, wherein the Young's modulus is between 900 N/mm² and 1100 N/mm².

14. The electrical cable splice of claim 1, wherein the dimensionally recoverable sleeve has a melting point greater than 90° C.

15. The electrical cable splice of claim 14, wherein the melting point is between 110° C. and 120° C.

16. The electrical cable splice of claim 1, wherein the dimensionally recoverable sleeve is formed from a high-density polyethylene, a low-density polyethylene, a polyoxymethylene, or a polyamide 12.

17. The electrical cable splice of claim 1, further comprising a clamping piece encompassing the dimensionally recoverable sleeve in a peripheral region of the dimensionally recoverable sleeve.

18. A method for electrically connecting a plurality of power cables, comprising:
exposing an electrically conductive core of each of the plurality of power cables;
joining the conductive cores of the plurality of power cables in a connection region; and
dimensionally recovering a sleeve to cover the connection region, the sleeve mechanically and electrically connecting the conductive cores to each other.

19. The method of claim 18, wherein the joining step comprises overlapping the conductive cores to a predetermined length of overlap in the connection region.

20. The method of claim 18, wherein the dimensionally recovering step comprises heat shrinking a heat shrink material of the sleeve.

21. The method of claim 18, wherein the dimensionally recovering step comprises recovering an expanded cold shrink material of the sleeve.

22. The method of claim 18, further comprising arranging a contact between the conductive cores, the contact is a flat, electrically conductive sheet having a roughened surface on each of two opposite sides of the contact.

23. The method of claim 18, further comprising attaching an electrically conductive flexible sheath between the sleeve and the conductive cores in the connection region.

24. The method of claim 23, wherein the attaching step comprises wrapping a woven or braided metal sheet around the joined conductive cores.

25. The method of claim 18, further comprising attaching a clamping piece encompassing the sleeve in a peripheral region of the sleeve.
